(19) United States
(12) Patent Application Publication
(10) Pub. No.: US 2008/0034157 A1
(43) Pub. Date: Feb. 7, 2008

(54) Massively parallel data storage and processing system

(76) Inventor: Paul S. Cadaret, Rancho Santa Margarita, CA (US)

Correspondence Address: Crockett & Crockett, Suite 400, 24012 Calle De La Plata, Laguna Hills, CA, 92653, US

(21) Appl. No.: 11/786,061

(22) Filed: Apr. 9, 2007

Related U.S. Application Data
(60) Provisional application No. 60/790,045, filed on Apr. 7, 2006.

(51) Int. Cl. G06F 12/00

(52) U.S. Cl. 711/114

(57) ABSTRACT

A distributed processing data storage system utilizing optimized methods of data communication between elements and that effectively collaborate to create and expose various types of unusual data storage objects. In preferred embodiments, such data storage systems would utilize effective component utilization strategies at every level to implement efficient and high-performance data storage objects with varying capabilities. Data storage object capabilities include extremely high data throughput rates, extremely high random-access I/O rates, efficient physical versus logical storage capabilities, scalable and dynamically reconfigurable data throughput rates, scalable and dynamically reconfigurable random-access I/O rates, scalable and dynamically reconfigurable physical storage capacity, scalable and dynamically reconfigurable levels of data integrity, scalable and dynamically reconfigurable levels of data availability, and other data storage object figures of merit.

### RELATED APPLICATIONS

This application claims priority from copending U.S. Provisional patent application 60/790,045 filed Apr. 7, 2006.

### FIELD OF THE INVENTIONS

The inventions described below relate to the field of digital data storage and more specifically to large capacity digital data storage systems incorporating distributed processing techniques.

### BACKGROUND OF THE INVENTIONS

Modern society increasingly depends on the ability to effectively collect, store, and access ever-increasing volumes of data. The largest data storage systems available today generally rely upon sequential-access tape technologies. Such systems can provide data storage capacities in the petabyte (PB) and exabyte (EB) range with reasonably high data-integrity, low power requirements, and at a relatively low cost. However, the ability of such systems to provide low data-access times, provide high data-throughput rates, and service large numbers of simultaneous data requests is generally quite limited.

The largest disk-based data storage systems (DSS) commercially available today can generally manage a few hundred terabytes (TB) of random access data storage capacity, provide relatively low data-access times, provide reasonably high data-throughput rates, good data-integrity, provide good data-availability, and service a large number of simultaneous user requests. Unfortunately, such disk-based systems generally utilize fixed architectures that are not scalable to meet PB/EB-class needs, they generally have large power requirements, and they are quite costly. Therefore, such architectures are not generally suitable for use in developing PB/EB-class or ultra high performance data storage system (DSS) solutions.

Modern applications are becoming ever more common that require data storage systems with petabyte and exabyte data storage capacities, very low data access times for randomly placed data requests, high data throughput rates, extremely high data-integrity, extremely high data-availability, and provide such features at a cost lower than other alternative data storage systems available today. Currently available data storage system technologies are generally unable to meet such demands and this causes IT system engineers to make undesirable design compromises when constructing such systems. The basic problem encountered by designers of such data storage systems is generally that of insufficient architectural scalability, flexibility, and reconfigurability.

Recent developments are now exposing needs for increased access to more data at faster rates with decreased latency and at lower cost. These needs are subsequently driving more demanding requirements for exotic high-performance data storage systems. These data storage system requirements then demand new types of data storage system architectures, implementation methods, and component designs that effectively address these demanding and evolving data storage system requirements in new and creative ways. What is needed are innovative techniques to meet these new requirements.

One method specifically described in later sections of this disclosure is a method of implementing unusually large RAID-set or RAID-like data storage objects (DSO) so that very high data throughput rates can be achieved. As described in detail in later figures, the methods disclosed allow RAID and RAID-like DSOs to be instantiated. If “N” reflects the number of data storage modules (DSM) units within a RAID-set, if “N=1000”, common RAID methods in use today become generally impractical. As an example, if RAID-6 encoding were used on a large RAID-set DSO, then that DSO would be able to tolerate up to two DSM failures before a loss of data integrity would occur. Given that a very large and high data availability system configuration might be required to tolerate the loss-of or the inability-to-access 10, 20, or more DSM units as a result of any equipment or network failure, then existing RAID-encoding methods can be shown to be generally inadequate. Under such conditions a loss of data integrity or data availability would generally be inevitable.

Other error correcting code methods that can accommodate such failure patterns are well known and include Reed-Solomon error correction techniques. However, such techniques are generally accompanied by a significant computational cost and have not seen widespread use as a replacement for common RAID techniques. Given the need for extended RAID encoding methods with large DSOs, the scalable DSO data processing methods described in this disclosure generally provide a means to apply the amount of processing power needed to implement more capable error correcting techniques. This generally makes such error correcting techniques useful in the data storage system domain.

### SUMMARY OF THE INVENTIONS

The present disclosure describes distributed processing methods for the purpose of implementing both typical and atypical types of data storage systems and various types of data storage objects (DSO) contained therein. For the purposes of the current disclosure we use the term DSO to describe data storage objects within a digital data storage system that exhibit conventional or unusual behaviors. Such DSOs can generally be constructed using software alone on commercial off the shelf (COTS) system components; however, the ability to achieve extremely high DSO performance is greatly enhanced by the methods described herein.

One or more Network Attached Disk Controllers (NADC) may be aggregated to form a collection of NADC units which may operate collaboratively on a network to expose multiple RAID and RAID-like DSOs for use. Methods are described whereby collections of data storage system (DSS) network nodes can be aggregated in parallel and/or in series using time-division multiplexing to effectively utilize DSS component data storage and data processing capabilities. These collections of components are then shown to enable effective (and generally optimized) methods of network aggregation and DSS/DSO function.

These aggregation methods (specifically the time-division multiplexing method shown in FIG. 9) provide a generally optimized methodology by which various types of DSS functions can be implemented. Since COTS RAID-type data storage systems provide many desirable characteristics needed in large-capacity and high-performance data storage systems, but they generally suffer from various limitations or bottlenecks when extended to PB/EB class data storage capacities, detailed descriptions are provided regarding several innovations that enable unified PB/EB-class DSS configurations to be created, used, and maintained. These innovations include: (a) effective (and generally optimized) aggregation methods for using networked DSS components to provide DSO data storage, data processing, control, and administrative functions, (b) methods of allocating and reallocating DSS components for different uses over time to meet changing system performance demands, (c) methods that eliminate or substantially reduce performance bottlenecks in large systems, (d) methods for the effective implementation of RAID and RAID-like DSOs, (e) methods for effective RAID and RAID-like DSO error recovery, (f) methods for effectively creating, using, and maintaining very large RAID or RAID-like DSOs, (g) one-dimensional and two-dimensional methods to improve DSO IO-rate performance, (h) methods to dynamically adapt IO-rate performance, (i) methods to initially configure physical data storage to a DSO virtual data space and have the mapping adapt over time, and (j) methods to implement multi-level or “layered” massive (PB/EB-class) data storage systems.

Two important metrics of performance for disk based COTS data storage systems are sustained data throughput and random-access IO rates. Maximizing DSS performance from a data throughput perspective can often be most directly achieved through the use of larger RAID or RAID-like DSOs or by effectively aggregating such DSOs. Therefore, much emphasis is placed on discussing methods to improve the performance of RAID and RAID-like DSOs via the effective aggregation methods disclosed.

Maximizing DSS performance from a IO-rate perspective is often achieved in COTS data storage systems using RAM caching techniques. Unfortunately, RAM caching becomes generally less effective as the data storage capacity of a system increases. Therefore, much emphasis is placed on discussing methods to improve system performance through the use of innovative cooperative groups of NADCs and data storage modules (DSM). Several such configurations are described in detail. These include one-dimensional Parallel Access Independent Mirror DSO (1D-PAIMDSO), the two-dimensional PAIMDSO, the Adaptive PAIMDSO (APAIMDSO), and a sparse-matrix APAIMDSO. Each PAIM variation is described to address a specific type of need related primarily to increased IO-rate capability.

Since demanding database usage requirements often drive IO-performance requirements, the following tables will describe some capabilities of the various types of PAIMDSO constructs whose implementation will be described later in detail. The following table explores some read-only 2D-PAIMDSO configurations with up to 50×50 (2500) DSM units independently employed.

PAIMDSO R-O Performance Calculations

| Calculations shown measured in units of: | IO-Ops/sec |
|---|---|
| Basic disk drive IO rate (IO-ops/sec): | 100 |
| Inefficiency factor (%): | 0% |

| | | PAIM Drives in Row | | | | | |
|---|---|---|---|---|---|---|---|
| | | 1 | 10 | 20 | 30 | 40 | 50 |
| PAIM Drives | 1 | 100 | 1,000 | 2,000 | 3,000 | 4,000 | 5,000 |
| in Col | 10 | 1,000 | 10,000 | 20,000 | 30,000 | 40,000 | 50,000 |
| | 20 | 2,000 | 20,000 | 40,000 | 60,000 | 80,000 | 100,000 |
| | 30 | 3,000 | 30,000 | 60,000 | 90,000 | 120,000 | 150,000 |
| | 40 | 4,000 | 40,000 | 80,000 | 120,000 | 160,000 | 200,000 |
| | 50 | 5,000 | 50,000 | 100,000 | 150,000 | 200,000 | 250,000 |

The above table assumes the use of a rather slow 10 msec per seek (and IO access) commodity disk drive. Such a DSM unit would be capable of approximately 100 IO-operations per second. The following table explores read-write performance in a similar way.

PAIMDSO R-W Performance Calculations

| Calculations shown measured in units of: | IO-Ops/sec |
|---|---|
| Basic disk drive IO rate (IO-ops/sec): | 100 |
| Inefficiency factor (%): | 10% |

| | | PAIM Drives in Row | | | | | |
|---|---|---|---|---|---|---|---|
| | | 1 | 10 | 20 | 30 | 40 | 50 |
| PAIM Drives | 1 | 100 | 910 | 1,810 | 2,710 | 3,610 | 4,510 |
| in Col | 10 | 1,000 | 9,100 | 18,100 | 27,100 | 36,100 | 45,100 |
| | 20 | 2,000 | 18,200 | 36,200 | 54,200 | 72,200 | 90,200 |
| | 30 | 3,000 | 27,300 | 54,300 | 81,300 | 108,300 | 135,300 |
| | 40 | 4,000 | 36,400 | 72,400 | 108,400 | 144,400 | 180,400 |
| | 50 | 5,000 | 45,500 | 90,500 | 135,500 | 180,500 | 225,500 |

The table above assumes that approximately 10% of the IO-rate performance of the array would be lost when performing read-write operations due to the need to replicate data within the DSM array. The concept of PAIMDSO data replication is explained in detail later.

The next table explores the need for IO-rate enhancements as might be necessary to support some very large database applications. Such applications might be the underlying technology used by some of the large Internet search sites such as google.com or yahoo.com. These search sites serve the world and as such they are very active with simultaneous (database) search requests. The next table outlines some example database transaction rates that these sites might experience.

Site Search Request Rate

| | |
|---|---|
| Calculations shown measured in units of: | Searches/sec |

| | | # Users | | | | | |
|---|---|---|---|---|---|---|---|
| | | 100 | 500 | 1000 | 2000 | 5000 | 10000 |
| Min per search | 0.25 | 6.7 | 33.3 | 66.7 | 133.3 | 333.3 | 666.7 |
| (average) | 0.50 | 3.3 | 16.7 | 33.3 | 66.7 | 166.7 | 333.3 |
| | 1.00 | 1.7 | 8.3 | 16.7 | 33.3 | 83.3 | 166.7 |
| | 2.00 | 0.8 | 4.2 | 8.3 | 16.7 | 41.7 | 83.3 |
| | 5.00 | 0.3 | 1.7 | 3.3 | 6.7 | 16.7 | 33.3 |
| | 10.00 | 0.2 | 0.8 | 1.7 | 3.3 | 8.3 | 16.7 |
| | 20.00 | 0.1 | 0.4 | 0.8 | 1.7 | 4.2 | 8.3 |

The above table shows how such a search engine may have varying numbers of users active at any point in time making search requests at different intervals. The table then lists the data base search rate in searches per second. Since database searches may result in tens, hundreds, or even thousands of subordinate IO subsystem read/write operations, database performance is often tied directly to the performance of the underlying supporting IO subsystem (the data storage subsystem). The following table provides a series of calculations for IO subsystem operation rates as a function of database search request rate and the average number of IO-operations required to satisfy such requests.

Database IO-Rate Requirements

| | |
|---|---|
| Calculations shown measured in units of: | IO-ops/sec |

| | | search requests/sec | | | | | | |
|---|---|---|---|---|---|---|---|---|
| | | 1 | 5 | 10 | 50 | 100 | 500 | 667 |
| # IO-ops | 1 | 1 | 5 | 10 | 50 | 100 | 500 | 667 |
| per request | 10 | 10 | 50 | 100 | 500 | 1,000 | 5,000 | 6,670 |
| (average) | 20 | 20 | 100 | 200 | 1,000 | 2,000 | 10,000 | 13,340 |
| | 30 | 30 | 150 | 300 | 1,500 | 3,000 | 15,000 | 20,010 |
| | 40 | 40 | 200 | 400 | 2,000 | 4,000 | 20,000 | 26,680 |
| | 50 | 50 | 250 | 500 | 2,500 | 5,000 | 25,000 | 33,350 |
| | 100 | 100 | 500 | 1,000 | 5,000 | 10,000 | 50,000 | 66,700 |
| | 200 | 200 | 1,000 | 2,000 | 10,000 | 20,000 | 100,000 | 133,400 |
| | 500 | 500 | 2,500 | 5,000 | 25,000 | 50,000 | 250,000 | 333,500 |
| | 1000 | 1,000 | 5,000 | 10,000 | 50,000 | 100,000 | 500,000 | 667,000 |
| | 2000 | 2,000 | 10,000 | 20,000 | 100,000 | 200,000 | 1,000,000 | 1,334,000 |
| | 5000 | 5,000 | 25,000 | 50,000 | 250,000 | 500,000 | 2,500,000 | 3,335,000 |

As can be seen in the above table, the average number of IO subsystem data access requests required to satisfy a database search request can dramatically affect the associated IO-rate performance requirement. Given that most COTS disk-based data storage systems are only capable of servicing a few thousand IO operations/second without caching, such systems generally do not provide a comprehensive solution to meet such demanding database needs. The above table then highlights the need for effective methods by which data storage systems can provide highly scalable, flexible, and dynamically adaptable DSOs.

Specific DSO implementation methods are described in detail later in this disclosure. These DSO implementation methods will be shown to provide the means to meet extremely high-performance needs. One DSO example disclosed will be shown to provide very high data access rates under high IO-rate random-access conditions as are often needed by large database applications. Other DSO examples disclosed may be capable of providing extremely high data throughput rates within a large DSS configuration.

### BRIEF DESCRIPTION OF THE DRAWINGS

FIG. 1 is a logical block diagram of a single Network Attached Disk Controller (NADC) unit.

FIG. 2 is a logical block diagram of a single low-performance RAID system configuration consisting of 256 Data Storage Module (DSM) components evenly distributed across 16 NADC units.

FIG. 3 is a physical connectivity block diagram showing 64 NADC units or other processing nodes interconnected by networking components and network links of various data throughput capacities.

FIG. 4 is a logical connectivity diagram that shows an alternate way of viewing the network topology of FIG. 3 for a subset of 16 NADC or other devices.

FIG. 5 is a block diagram based on FIG. 4 that illustrates how various data storage system resources can be cooperatively applied to implement arbitrary amounts of pipeline processing power for the benefit of various DSOs distributed throughout a data storage system configuration.

FIG. 6 is a block diagram based on FIG. 4 that illustrates how data storage system resources can be applied to implement arbitrary amounts of parallel processing power for the benefit of various DSOs distributed throughout a data storage system configuration.

FIG. 7 is a block diagram based on FIG. 4 that illustrates an alternate view of how arbitrary amounts of data storage system parallel processing power can be applied to the benefit of system configurations implementing various types of DSOs.

FIG. 8 is a block diagram that illustrates an example configuration of applying a group of discrete NADC/other data storage system resources applied to the benefit of system configurations implementing various types of DSOs.

FIG. 9 is a timing diagram that illustrates an example configuration of cooperatively applying a group of discrete NADC/other data storage system resources to accelerate or otherwise improve DSO required processing.

FIG. 10 is a logical block diagram of a relatively large distributed processing data storage system configuration consisting of 176 NADC units with 2816 DSM units attached that provides a number of opportunities for instantiating various types of DSOs.

FIG. 11 is a logical data flow diagram that shows how a RAID-set or other type of roughly similar DSO might process data being read from a DSO while making use of arbitrary amounts of data storage system processing resources.

FIG. 12 is a logical data flow diagram similar to FIG. 11 that illustrates how the scalable amount of DSO management processing power can be harnessed during an error recovery processing scenario.

FIG. 13 is a timing diagram that describes how an arbitrarily large RAID-set or other type of similar DSO might continue to exhibit the behaviors of data integrity and data availability despite numerous DSM, NADC, or other types of system component failures.

FIG. 14 is a block diagram that illustrates the general operational methods associated with a One-Dimensional Parallel Access Independent Mirror DSO (1D-PAIMDSO) that is focused on providing increased read-only IO-rate or data-throughput performance.

FIG. 15 is a block diagram that illustrates the general operational methods associated with a 1D-PAIMDSO that is focused on providing increased read-write DSO IO-rate or data-throughput rate performance.

FIG. 16 is a block diagram that illustrates the general operational methods that can be employed to implement a two-dimensional PAIMDSO (2D-PAIMDSO) that is focused on providing extremely fast and highly adaptable read-write IO-rate or data-throughput rate performance.

FIG. 17 is a block diagram based that illustrates some of the general operational methods that can be employed to implement a one-dimensional Adaptive PAIMDSO (1D-APAIMDSO) as it transitions through different phases of zone replication, IO-rate performance, and/or data throughput rate performance over time.

FIG. 18 is a block diagram that illustrates some of the general operational methods that can be employed to implement an Adaptive PAIMDSO (2D-APAIMDSO) when operating as a logical sparse matrix with physical data storage capacity added as needed over time.

FIG. 19 is a logical network connectivity diagram based on FIG. 4 that illustrates how massive (PB-class or EB-class) high-performance data archival systems might be constructed as a series of data storage “zones” or “layers”.

### DETAILED DESCRIPTION OF THE INVENTIONS

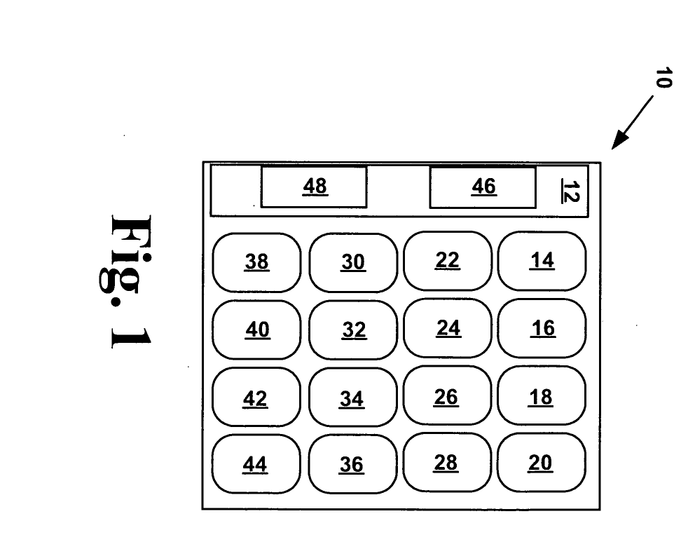

Referring to FIG. 1, a Network Attached Disk Controller (NADC) unit 10 subject to the current disclosure is shown. The diagram shown 10 represents the typical functionality presented to a data storage system network by an embodiment of a NADC unit with a number of attached or control Data Storage Module (DSM) units. In this figure the block of NADC-DSM functionality 10 shows sixteen DSM units (14, 16, 18, 20, 22, 24, 26, 28, 30, 32, 34, 36, 38, 40, 42, and 44) attached to the NADC unit 12. In this example an embodiment with multiple (two in this case) NADC network interfaces are shown as 46 and 48. Such network interfaces could represent Ethernet interfaces, Fibre-Channel (FC) interfaces, or other types of network communication interfaces.

It is generally anticipated that each NADC unit such as NADC 10 can be used to perform multiple purposes such as DSM control, DSO processing, higher level data storage system (DSS) functions, and any other suitable purposes. NADC units are generally anticipated to be allocatable blocks of data storage and/or processing resources. Such storage/processing resources within each NADC may be allocated and applied either together or independently.

It is also anticipated that NADC/other resources may be useful as general-purpose data processing elements. Given that large numbers of NADC/other network nodes may be employed in a large data storage system (DSS) configuration, it is possible that some or all of the functionality of large numbers of such nodes may be unused at any point in time. In such operating scenarios it is envisioned that the processing power of such nodes may be managed, dynamically allocated, and used for purposes related to DSS operation or for generalized data processing purposes. Given that these units are typically well connected to the DSS network, the network locality of these processing resources may be exploited for optimal effect.

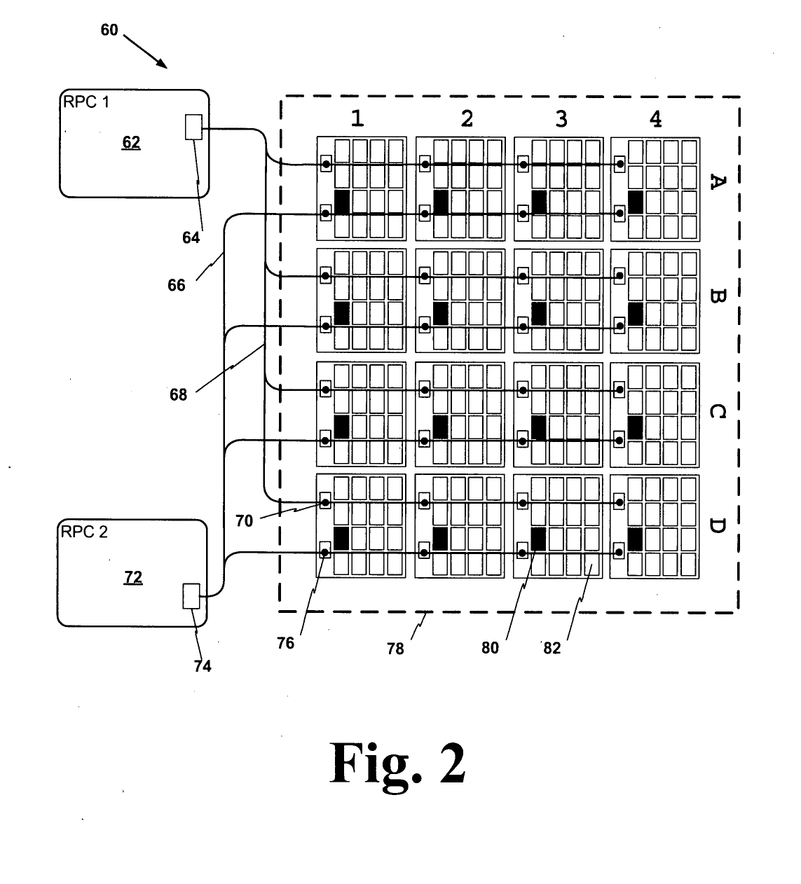

Referring to FIG. 2, an example small distributed processing RAID system component configuration 60 subject to the current disclosure is shown. The block diagram shown 60 represents a 4×4 array of NADC units 78 arranged to effectively present multiple DSM units as a service to the data storage system network. In this example a RAID-set or RAID-like DSO is shown formed by sixteen DSM units that are distributed widely across the entire array of NADC units. This constitutes one type of embodiment. The DSM units that comprise this DSO are shown representatively as 80. Those DSM units that are not a part of the example DSO of interest is shown representatively as 82.

Given the NADC network connectivity representatively shown as 70 and 76, it is possible that either or both of the two RAID Parity Calculation (RPC) logical blocks shown as 62 and 72 could simultaneously communicate with the various NADC/DSM units that embody the DSO shown. In this example RPC block 62 could communicate with the 4×4 array of NADC units via the logical network communication link 68. Alternatively, RPC unit 72 might similarly communicate with the NADC-DSM units via the logical network communication link 66.

Numerous DSO configurations can be instantiated and simultaneously active with such a distributed implementation method.

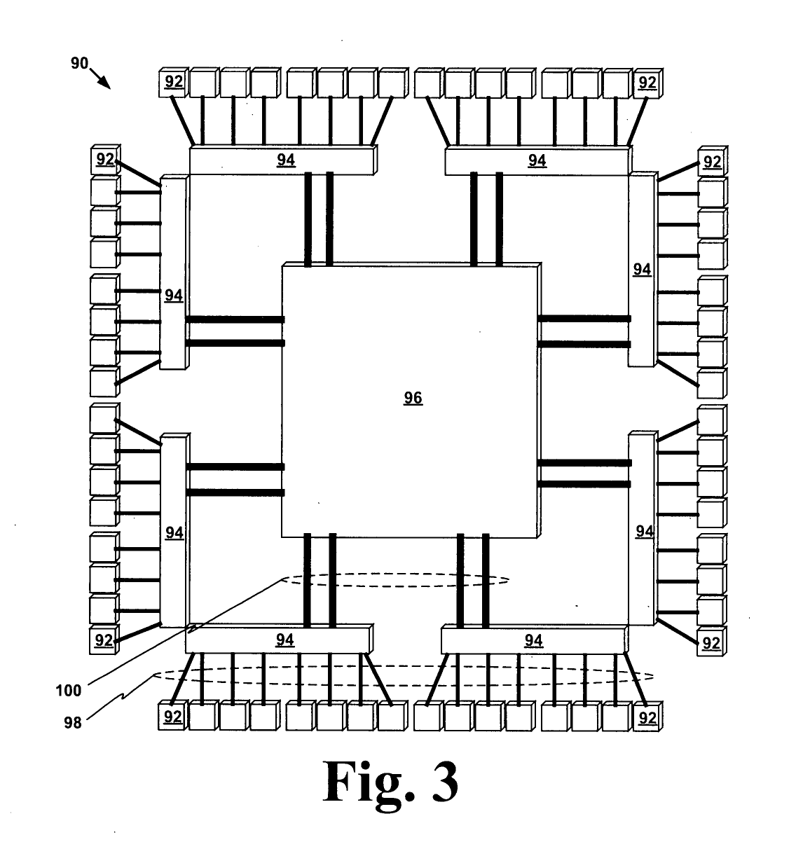

Referring to FIG. 3, an example configuration of 64 NADC or other Specialized Processing Units (SPU) interconnected by various networking components 90 subject to the present disclosure is shown. SPUs might be special-purpose network nodes designed to efficiently provide some form of data processing or management services relevant to a particular DSS configuration.

The block diagram shown represents a 16×4 array of NADC/SPU units 92 arranged to present data storage and processing services to an overall data storage system network. In this example each NADC/SPU unit 92 is attached via a logical network link shown representatively by 98 to a Level-1 network switch 94. Each Level-1 network switch 94 is then connected via network links of generally higher-speed that are shown representatively by 100 to a Level-2 network switch 96. Larger systems can be similarly constructed.

In a distributed DSS architecture network bandwidth would generally be treated as a precious system resource and the network architecture would generally be tailored to meet the needs of a specific DSS configuration. In an efficient implementation, network bandwidth throughout a system would be measured, predicted, tracked, managed, and allocated such that various measures of DSO behavior can be prioritized and managed throughout a DSS system configuration.

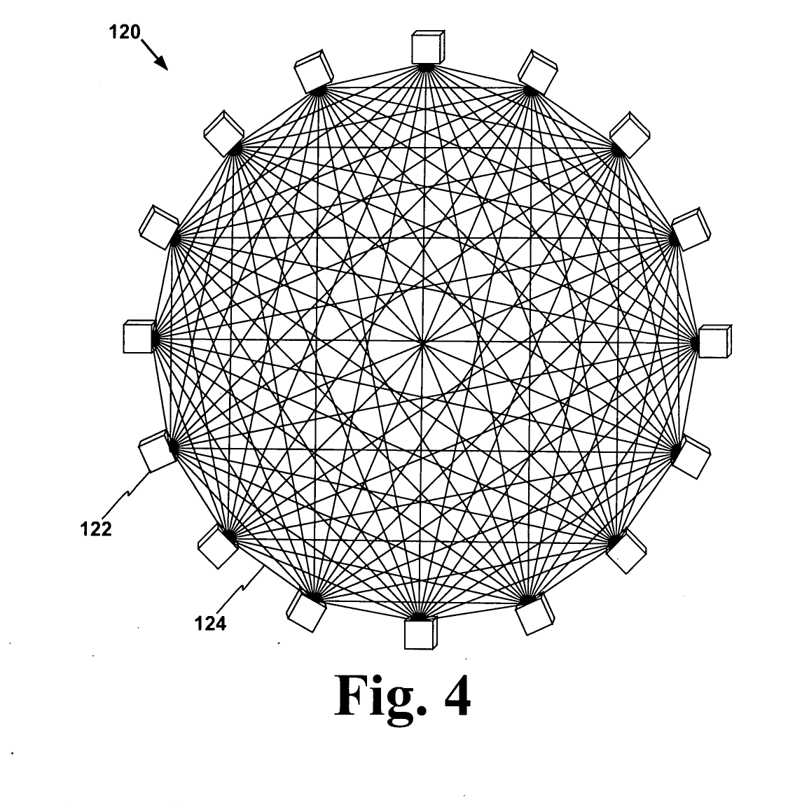

Referring to FIG. 4, an example configuration of 16 NADC/SPU units interconnected by various logical network connectivity paths 120 subject to the present disclosure is shown. Each NADC/SPU unit is shown representatively as 122 and is connected with every other NADC/SPU unit via an available discrete logical network communication path. The discrete network communication paths are shown representatively as 124.

This figure highlights the fact that network connectivity is generally available from any point on the data storage system (DSS) network to any other point on the network. Although we recognize that connectivity bandwidth may vary in a large system configuration due to the details of a network topology, for clarity this fact is not reflected in this figure.

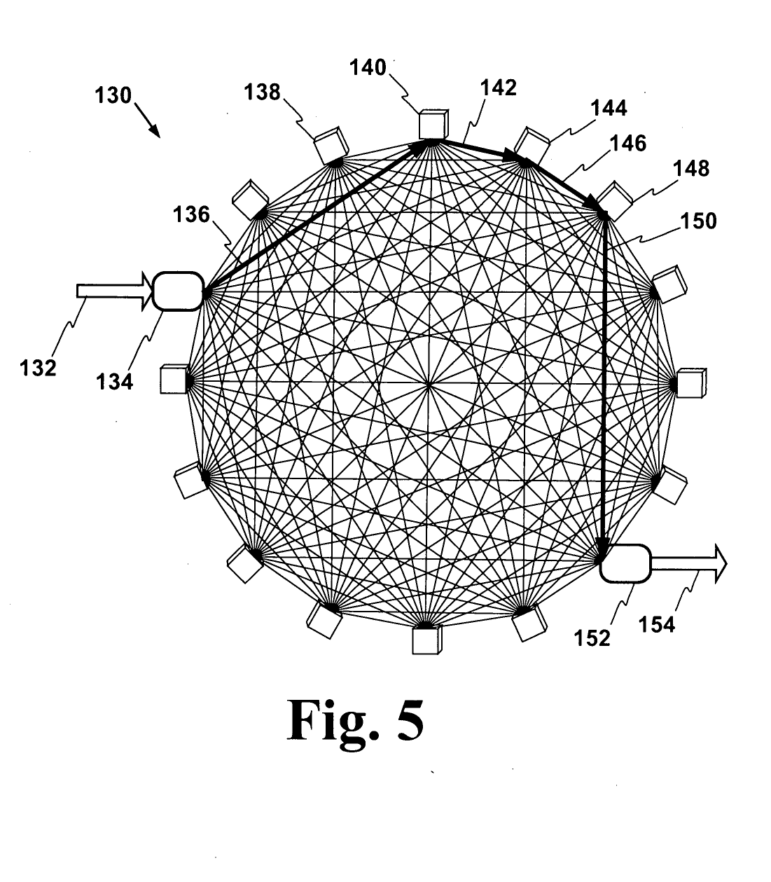

Referring to FIG. 5, an example configuration of 16 data storage system network nodes interconnected by various logical network connectivity paths being utilized to implement a pipeline processing method 130 subject to the present disclosure is shown. In this figure a high-speed communication link 132 delivers data to a node on the DSS network 134. Node 134 may be an NADC/SPU unit or it may be some external client system attached to the data storage system (DSS) network. Inactive or non-allocated NADC/SPU units relative to the highlighted processing pipeline are shown representatively as 138. Node 134 communicates with one or more NADC/SPU units (shown as 140, 144, 148) to perform various functions as needed to support DSO or other processing operations and the processed information is then delivered to one or more recipient network nodes (shown representatively as 152). Nodes(s)152 may then communicate with further network nodes via the logical network link shown as 154. The various network nodes (134, 140, 144, 148, and 152) form a pipeline of sequential or layered processing elements that communicate via the logical network pathways shown as 136, 142, 146, and 150 within the DSS network.

Each network node shown is anticipated to provide some level of service related to exposing one or more DSO management or processing capabilities on the DSS network. From a DSO processing perspective, the capabilities needed to expose DSO services may be allocated as needed from the pool available NADC/SPU units within a given DSS component configuration.

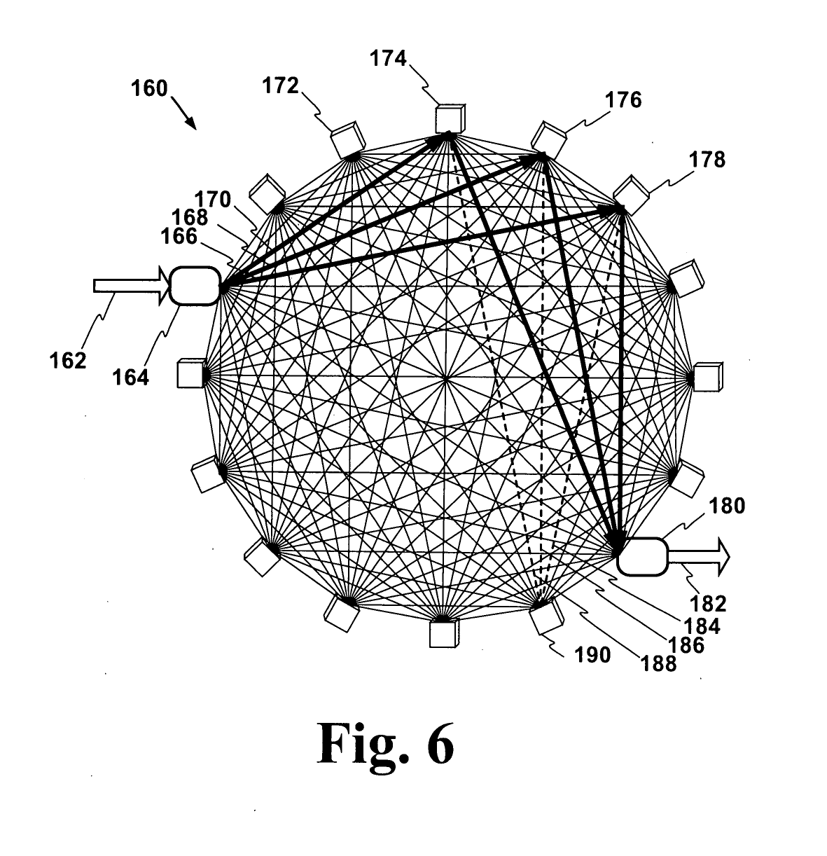

Referring to FIG. 6, an example configuration of 16 NADC/SPU units interconnected by various logical network connectivity paths being utilized to implement a parallelized processing system 160 subject to the present disclosure is shown. In this figure a high-speed communication link 162 delivers data to a node on the data storage system network 164. Node 164 may be a NADC/SPU unit or it could be a client system that accesses the distributed data storage system. Inactive or non-allocated NADC/SPU units are shown representatively as 172. In this example node 164 communicates with several NADC/SPU units in parallel (174, 176, and 178) to perform various processing functions as needed in parallel and the processed information is then shown being delivered to one or more network nodes shown representatively as 180. Network node(s) 180 may then utilize network link 182 to communicate with other system components. The various units (174, 176, 178) form a group of parallel processing elements that utilize the communication pathways represented by 166, 168; and 170 and others to provide significantly improved processing capabilities.

In this example an optional NADC/SPU unit 190 in shown communicating with various network nodes shown such as 174, 176, and 178 to provide administrative and control services that may be necessary to effectively orchestrate the operation of the services provided by these nodes. Each node on the network shown (174, 176, 178) in this example is anticipated to provide some level of service related to exposing DSO capabilities on the network. It should also be noted that the methods of parallelism and pipelining can be simultaneously exploited to provide higher-level and higher performing services within a single data storage system configuration where appropriate.

It is also anticipated that the administrative or control service shown as 190 may itself be implemented as a cluster of cooperating NADC/SPU network nodes (like 174, 176,178). Such distributed functions include: RAID-set management functions, management functions for other types of DSOs, management functions that allow multiple DSOs to themselves be aggregated, network utilization management functions, NADC/SPU feature management functions, data integrity management functions, data availability management functions, data throughput management functions, IO-rate optimization management functions, DSS service presentation layer management functions, and other DSS functions as may be necessary to allow for the effective use of system resources.

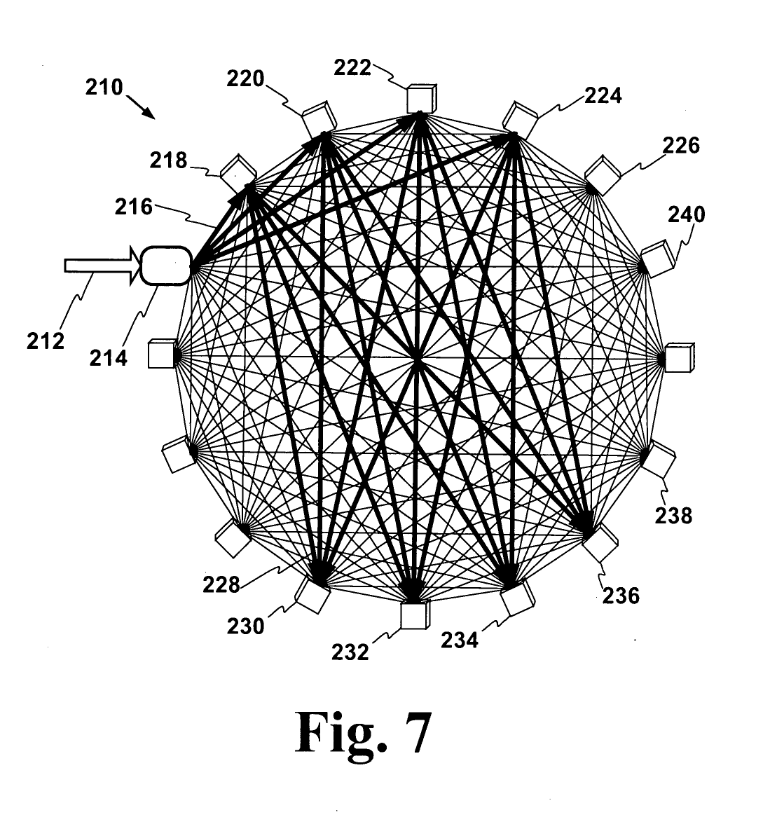

Referring to FIG. 7, an example configuration of 16 NADC/SPU units interconnected by various logical network connectivity paths being utilized to implement several functions 210 subject to the present disclosure is shown. In this figure a high-speed communication link 212 delivers data to a node on the data storage system network 214. Node 214 may be a NADC/SPU unit or it could be a client system that accesses the distributed data storage system. Inactive or non-allocated NADC/SPU units are shown representatively as 226. In this figure two layers of nodes are shown to be involved in the management of a DSO. Layer-1 consists of nodes 218, 220, 222, and 224. Layer-2 consists of nodes 230, 232, 234, and 236. Node 214 communicates with Layer-1 nodes via the highlighted network communication paths shown representatively by 216. All four Layer-1 nodes can communicate with any of the four Layer-2 nodes via the highlighted network communication paths shown representatively by 228. The nodes 238 and 240 are identified to represent possible candidates for allocation should increased DSO capabilities be required in either Layer-1 or Layer-2. Such capabilities might include higher-level processing functions as mentioned earlier, improved data throughput performance (increased RAID processing capability), improved I/O rate performance (increased DSO-data replication), distributed filesystem implementations, or other enhanced capabilities.

This figure anticipates the effective use of dynamically allocated system resources to make available data storage and/or processing capabilities to one or more requesting client system(s) 214 where appropriate.

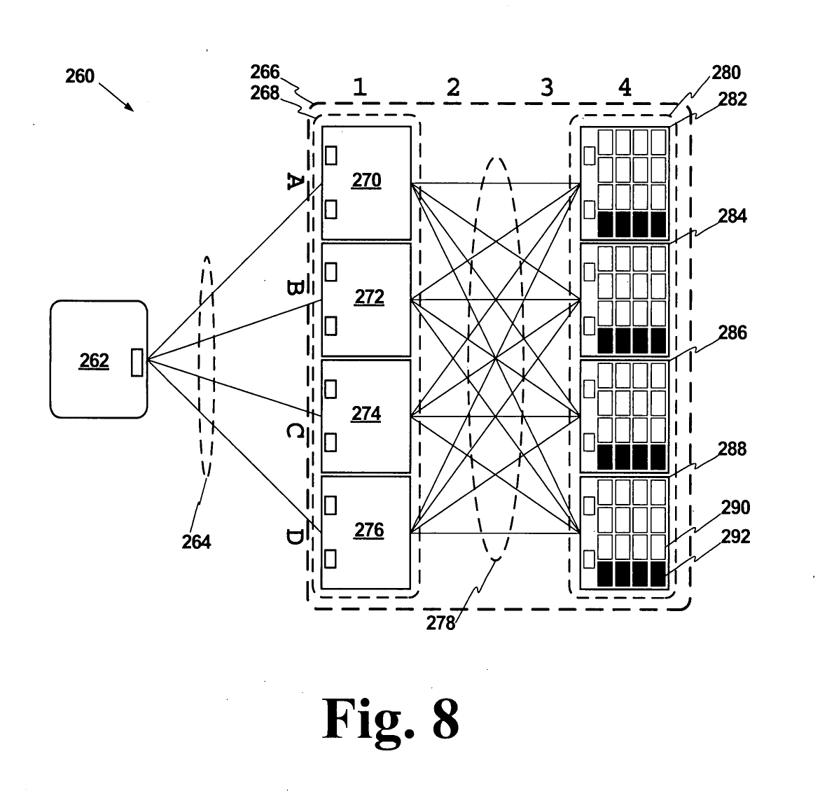

Referring to FIG. 8, an example system configuration of a client computer system(s) logically connected to a DSO 260 subject to the present disclosure is shown. This example amplifies the example shown in FIG. 7 by showing how the method can be applied within the framework of a 4×4 array of NADC/SPU nodes. In this example a client system 262 communicates with a DSO 266. The external service interface 268 of the DSO is shown by the collection of cooperating NADC/SPU nodes 270, 272, 274, and 276. An array of NADC units 280 composed of 282, 284, 286, and 288 is shown exposing the services of an array of DSM units via the DSS network. In this example we consider the array of active DSM units such as active DSM unit 292 to form a sixteen DSM RAID-set DSO. Unallocated or inactive DSM units are represented such as inactive DSM unit 290. The paths of possible DSS-internal network connectivity of interest to this example are shown as paths 278.

Although a high performance or highly reliable implementation may employ multiple such layers of nodes to support DSO management and DSO data processing purposes, for the purposes of this example such additional complexity is not shown. Considering this DSO as a RAID-set, DSO data processing (RAID-set processing) is generally of significant concern. As the number of DSM units in the RAID-set increases, DSO RAID-set data processing increases accordingly. If a RAID-set DSO were to be increased in size, it can eventually overwhelm the capacity of any single RAID-set data processing control node either in terms of computational capability or network bandwidth. For conventional systems that employ one or a small number of high-performance RAID controllers, this limitation is generally a significant concern from a performance perspective.

Because DSS systems that utilize centralized RAID controllers generally have RAID processing limitations both in terms of computational capabilities and network bandwidth, DSO bottlenecks can be a problem. Such bottlenecks can generally be inferred when observing the recommended maximum RAID-set size documented by COTS DSS system manufacturers. The limitations on RAID-set size can often be traced back to the capabilities of RAID-controllers to process RAID-set data during component failure recovery processing. Larger RAID-set sizes generally imply longer failure recovery times; long failure recovery times may place data at risk of loss should further RAID-set failures occur. It would generally be disastrous if the aggregate rate of DSM failure recovery processing were slower than the rate at which failures occur. Limiting RAID-set sizes generally helps DSS manufacturers avoid such problems. Also, long failure recovery times imply a reduced amount of RAID-controller performance for normal RAID-set DSO operations during the recovery period.

The methods illustrated in the current disclosure provide the means to generally avoid computational and communication bottlenecks in all aspects of DSS processing. In system 260 the storage component of a RAID-set, DSO 266, is distributed across a number of NADC units such as the units 280. This can increase data integrity and availability and provides for increased network bandwidth to reach the attached DSM storage, active elements such as element 292. As mentioned earlier, RAID-controller computational capabilities and network bandwidth are generally a limitation and concern. Distributing the RAID-controller computational processing function 268 across a number of dynamically allocatable NADC/SPU nodes such as nodes 270, 272, 274 and 276 allows this function to be arbitrarily scaled as needed. Additionally, because network bandwidth between DSS components 278 is scaled as well, this problem is also generally reduced. If an implementation proactively manages network bandwidth as a critical resource, predictable processing performance can generally be obtained.

When viewed from one or more nodes such as node 262 outside the DSS, the DSS and the DSO of interest in this example can provide a single high-performance DSO with a service interface distributed across one or more DSS network nodes. Because the capabilities of the DSO implementation can be scaled to arbitrary sizes, generally unlimited levels of DSO performance are attainable. Although a very large DSO implementation 266 may be so large that it might overwhelm the capabilities of any single client system 262, if the client 262 were itself a cluster of client systems, such a DSO implementation may prove very effective.

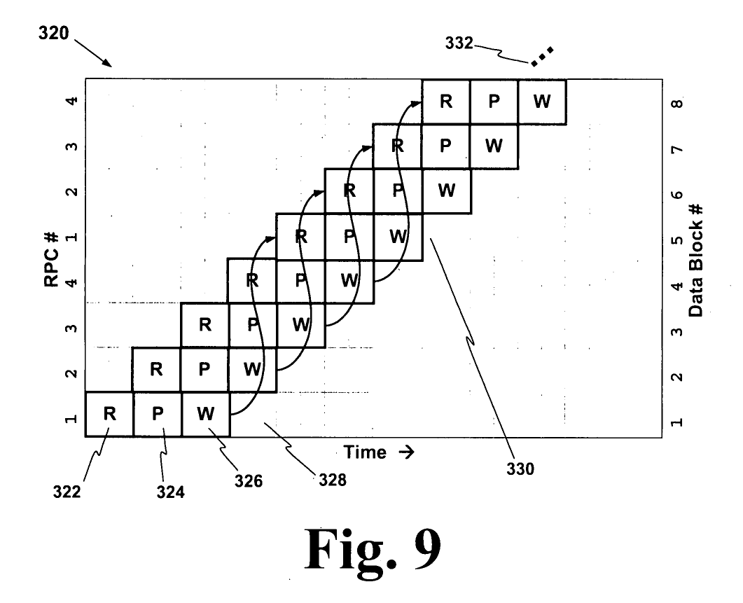

Referring to FIG. 9, an example timing diagram illustrating the effective use of distributed DSS/DSO functionality 320 subject to the present disclosure is shown. The figure shows one possible timing sequence by which a distributed DSO data processing sequence might occur. Block 322 shows a representative example of a network read operation. Block 324 shows a representative example of a computational processing operation. Block 326 shows a representative example of a network write operation. To put this processing sequence in further perspective, the rows shown as 328 and 330 might correspond to operations assigned to NADC/SPU node 270 as shown in FIG. 8. Item 332 is shown to reflect that the timing sequence shown might repeat indefinitely.

Considering a RAID-set DSO in this example, this might represent one possible logical sequence during the processing of a logical block of RAID-set data (read or write) operation. Presuming that the processing time is significant for a large/fast RAID-set (or other) DSO, it may prove helpful to share the processing load for a sequence of DSO accesses across multiple NADC/SPU nodes so that improved performance can be obtained. The figure shows a number of such blocks being processed in some order and being assigned to logical blocks of RPC (RAID processing) functionality. By performing time division multiplexing (TDM) of the processing in this way a virtually unlimited amount of RPC performance is generally possible. This can then reduce or eliminate processing bottlenecks when sufficient DSS resources are available to be effectively applied.

If should also be noted that the processing methodology shown in the figure can be applied to many types of DSS processing operations. Such a methodology can also generally be applied to such DSS operations as: DSS component allocation, network bandwidth allocation, DSO management, DSO cluster or aggregation management, distributed filesystem management operations, various types of data processing operations, and other operations that can benefit from a scalable distributed implementation.

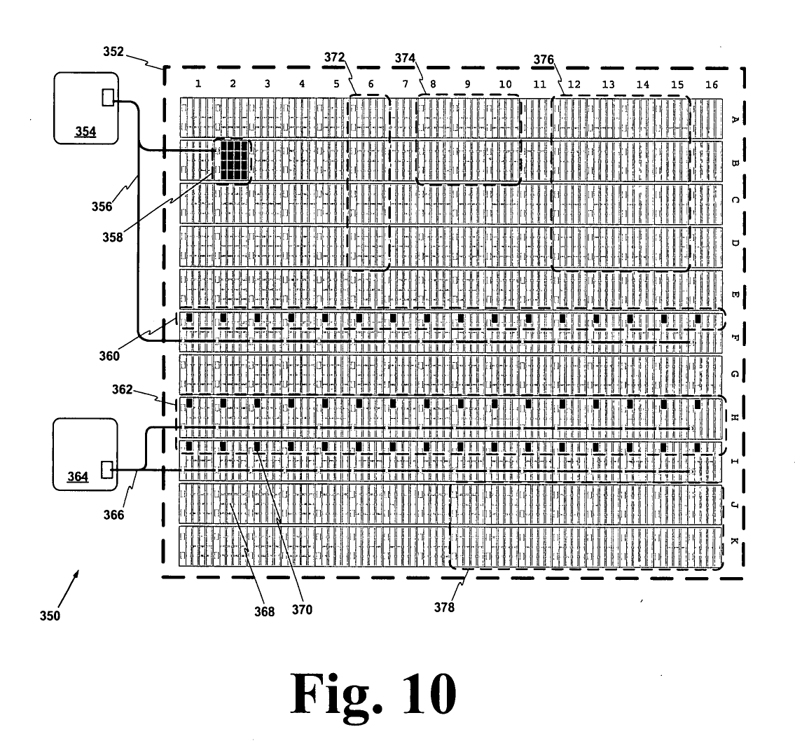

Referring to FIG. 10, an example system configuration of two client computer system(s) logically connected to a DSS system implementing multiple DSOs 350 subject to the present disclosure is shown. The example DSS configuration 352 shows an 11×16 array of NADC units with sixteen DSM units attached each. This provides a DSS component configuration of 11×16 (176) NADC units, 176×2 (352) network attachment points, and 176×16 (2816) DSM units available for allocation and use. In this example DSS configuration 352 three RAID-set DSOs are shown as 358, 360, and 362. DSO 358 shows a highly compact RAID-set with all DSM units sharing a single NADC unit and network links. DSOs 360 and 362 are widely distributed in the implementation shown such that improved performance is possible. The implementation of DSOs 360 and 362 as shown generally allows improved data integrity and data availability because single-point failures have reduced scope; also, data throughput is improved due to (among other things) increased network connectivity.

This example also shows two client systems (354 and 364) communicating with these three DSOs. Client system 354 communicates via the logical network link 356 to DSO 358 and 360. Client system 364 communicates via the logical network link 366 to DSO 362. An example of an inactive or unallocated DSM units is shown representatively by 368. An example of an active or allocated DSM units of interest to this example is shown representatively by 370.

This example also shows several other groups of NADC units with inactive DSM units as 372, 374, 376, and 378. As was described earlier in FIG. 8, such available NADC units may be allocated and used to enhance the performance capabilities of the active DSOs 358, 360, and 362 as needed. The processing capabilities would generally be applied as described in FIG. 9 to achieve enhanced performance as needed. It should be noted that the method described could instantiate DSOs with thousands of DSM units and hundreds of NADC/SPU units to achieve DSOs with unprecedented levels of performance or capability.

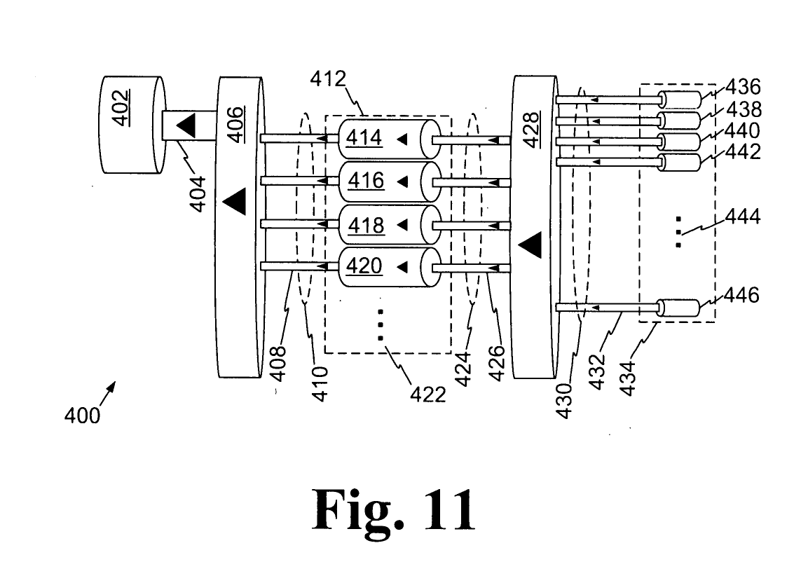

Referring to FIG. 11, a processing block diagram of a client computer system(s) logically connected via a network to a RAID-set DSO 400 subject to the present disclosure is shown. In this diagram the network bandwidth of one or more client systems 402 is shown reading data from a RAID-set 434 is shown. The system 402 communicates with the DSS/DSO via the network bandwidth (presumably a large “pipe”) shown as 404. This diagram primarily reflects RAID-set read-data bandwidth in a maximum performance application. Data is transferred during the read operation from the RAID-set 434 that consists of a number of NADC/DSM units shown as 436, 438, 440, 442, 444, and 446. Each NADC unit connects to the overall DSS network via a network links representatively shown as 432 and 430. Overall DSS network bandwidth 406 and 428 is shown as being designed to be sufficiently large so as not to be a bottleneck. RAID-set DSO processing is shown by block 412 that consists of a number of NADC/SPU nodes (414, 416, 418, 420, and 422) and connected to the overall DSS network via the network bandwidth 408, 410, 424, and 426.

Item 444 is intended to show that the RAID-set (or other) DSO can be scaled as necessary to arbitrary sizes subject to DSS component availability constraints. This generally means that RAID-set DSO data throughput can be scaled arbitrarily as well. Unfortunately, the realization of such highly scalable RAID-set (or other) DSO performance implies ever increasing data processing requirements. Hence, to avoid such RAID-set processing bottlenecks, item 422 is shows that RAID-set (or other) DSO processing capabilities can be scaled as necessary to arbitrary sizes subject to DSS component availability constraints.

This figure can also be used to express the current methods as applied to a DSO write operation if the direction of all the arrows shown within the various network links is reversed such that they all point to the right.

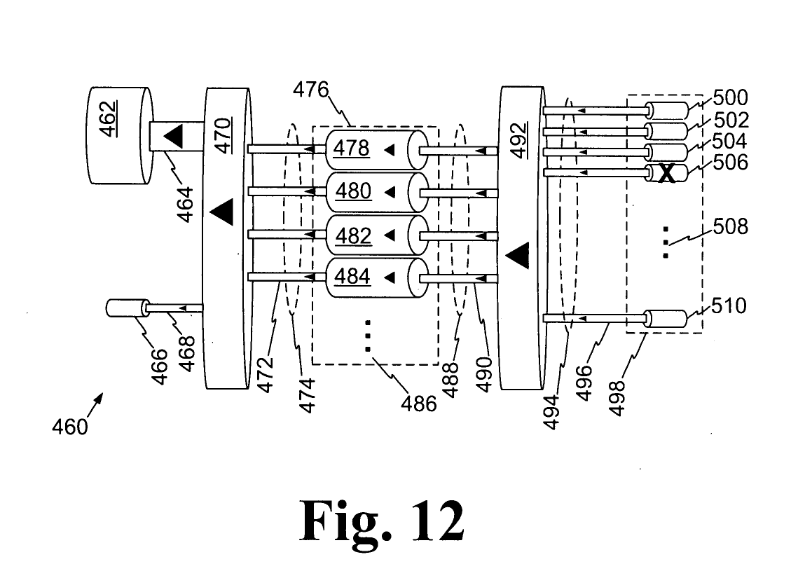

Referring to FIG. 12, a processing block diagram of a client computer system logically connected via a network to a RAID-set DSO that is engaged in a DSM failure error recovery operation 460 subject to the present disclosure is shown. This figure is very similar to FIG. 11 in that it shows one or more client systems 462 is shown reading data from a RAID-set 498. The primary difference in this example is that a NADC or DSM failure is shown as 506. Given that some form of RAID data encoding scheme is being employed by DSO 498, a single NADC/DSM failure may be entirely recoverable in real-time. Using a RAID-set as our DSO operational paradigm, as system 462 makes read requests of the DSO, the DSO storage management components deliver data blocks from the various remaining NADC/DSM components 500, 502, 504, 508, and 510 via the DSS network (explicitly without 506). The DSO data management block 476 observes the failure and recovers the DATA using the appropriate RAID-set computational methods. Given that the number of RAID-set failures is less than or equal to the maximum allowable number of device failures, DSO data integrity remain good and data availability remains good as well.

Although the DSO remains operational, the DSO management software (not shown) must take some action to recover from the current error condition or further failures may result in lost data or the data becoming inaccessible. To gracefully recover, an implementation is envisioned to have the DSO management software begin an automated recovery process where the following takes place:

A new NADC/DSM is allocated from the pool of available DSS units 466 so that the failed logical unit of storage can be replaced,

A read of the entire contents of the DSO data storage space 498 is performed,

For each block of still-readable data, the DSO data processing block 476 would use RAID-encoding computations to recover the lost data,

The DSO management software would cause all the data recovered for DSM 506 to now be written to DSM 466.

Upon the completion of the above sequence of steps, the data storage components of the RAID-set DSO would now be 500, 502, 504, 466, 508, and 510. At this point, the RAID-set DSO would be fully recovered from the failure of 506.

NADC/DSM 506 can be later replaced and the contents of 466 written back to the repaired unit 506 should the physical location of 506 provide some physical advantage (data integrity, data availability, network capacity, etc).

Depending on the criticality of the recovery operation the DSO management software might temporarily allocate additional NADC/SPU capacity 486 so that the performance effects of the recovery operation are minimized. Later, after the recovery operation such units might be deallocated for use elsewhere or to save overall DSS power.

It should also be mentioned that the above-described methodology generally provides a critical enabler to the creation, use, and maintenance of very large RAID-set DSOs. Because of the scalability enabled by the methods described, RAID-sets comprising thousands of NADC/DSM nodes are possible. Given the aggregate data throughput rate of a large RAID-set (or other) DSO, it is unlikely that any single RAID controller would suffice. Therefore, the scalable processing methodology described thus far generally provides a critical enabler for the creation, use, and maintenance of very large RAID-set (or other) DSOs.

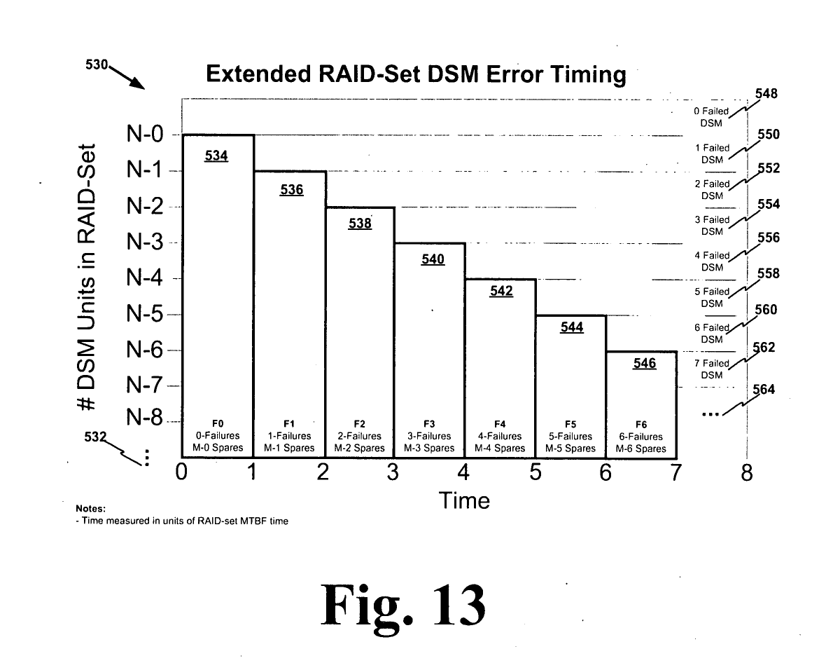

Referring to FIG. 13, a RAID-set failure timing diagram 530 subject to the present disclosure is shown. This diagram further amplifies the description provided for very large RAID-set (or similar) DSOs by showing how arbitrarily large RAID-sets with “N” drives degrade as failures occur. Graph label column 532 reflects the number of drives in a RAID-set (or similar) DSO as various failures occur. “N” may be a very large and generally unusual RAID-set size as compared with the capabilities of COTS data storage systems that are available today. Using the methods described in this disclosure, it is possible or practical to create, use, maintain RAID-set DSOs consisting of thousands of DSMs. Area 534 shows a block of time during which 0 failures are present in a large RAID or RAID-like DSO. Area 536 shows a block of time during which 1 failures are present in a large RAID or RAID-like DSO. Areas 538, 540, 542, 544, and 546 shows blocks of time during which more failures are present in a large RAID or RAID-like DSO. Correspondingly, 548, 55b, 552, 554, 556, 558, 560, and 562 represent areas of the timeline during which one or more failure conditions may be present.

By employing TDM or similar distributed data processing mechanisms RAID or RAID-like DSOs can be effectively created, used, and maintained. Considering that the amount of management processing power can be scaled greatly, extremely large RAID-like DSOs can be constructed.

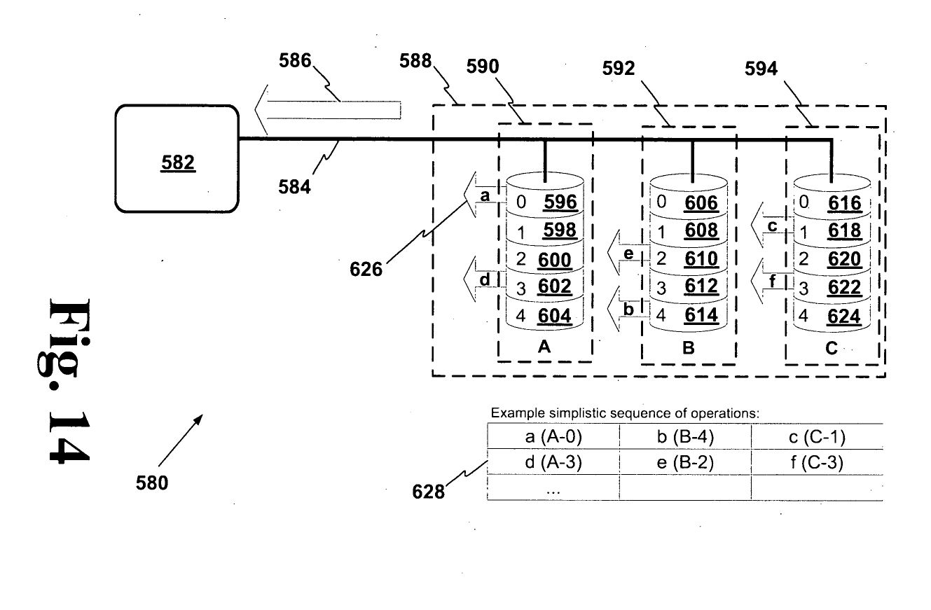

Referring to FIG. 14, an example system configuration of a client computer system(s) logically connected via a network to a DSO 580 subject to the present disclosure is shown. We refer to this configuration as a one-dimensional read-only Parallel Access Independent Mirror (PAIM) DSO (1D-PAIMDSO). In this figure a client computer system 582 logically communicates with a one-dimensional PAIMDSO (1D-PAIMDSO) 588 via a communication link 584. In this example, the DSO is envisioned to be archival and nature and therefore the client computer system only reads data from the DSO. This allows certain optimizations to be exploited. The predominant direction of data flow in this operating scenario is described by 586.

The DSO as shown consists of three columns of DSM units 590, 592 (“B”), and 594 (“C”). Each DSO column is shown with 5 DSM units contained within. Column 590 (“A”) contains DSM units 596 (drive-0), 598, 600, 602, and 604 (drive-4). Column 592 (“B”) contains DSM units 606 (drive-0), 608, 610, 612, and 614 (drive-4). Column 594 (“C”) contains DSM units 616 (drive-0), 618, 620, 622, and 624 (drive-4). Column 590 (“A”) may be a RAID-set or it may be a cooperative collection of DSM units organized to expose a larger aggregate block of data storage capacity, depending on the application. For the purposes of this discussion it will be assumed that each column consists of an array of five independently accessible DSM units and not a RAID-set. Identifier 626 shows a representative example of a data read operation (“a”) being performed from a region of data on DSM 596. The example embodiment of a read-only processing sequence shown is further described by the table shown as 628.

In this table read operations (“a”, “b”, or “c”) are shown along with their corresponding drive-column letter (“A”, “B”, or “C”) and drive-letter designation (“0” through “4”). This table provides one example of an efficient operating scenario that distributes the data access workload across the various drives that are presumed to all contain the same data.

It is envisioned that the original master copy of the DSO data set might start off as 590. At some point in time the DSO management software (not shown) adds additional data storage capacity in the form of 592 and 594. The replication of the data within 590 to 592 and 594 would then commence. Such replication might proceed either proactively or “lazily”. A proactive method might allocate some 590 data access bandwidth for the data replication process. A “lazy” method might replicate 590 data to 592 or 594 only as new reads to the DSO are requested by 582. In either case, as each new data block is replicated and noted by the DSO management software, new read requests by 582 can then be serviced by any of the available drives. As more data blocks are replicated, higher aggregate IO performance is achievable. Given that numerous columns such as 592 and 594 can be added, the amount of IO-rate performance scalability that can be achieved is limited largely by available DSS system component resources. This is one way of eliminating or reducing system performance bottlenecks.

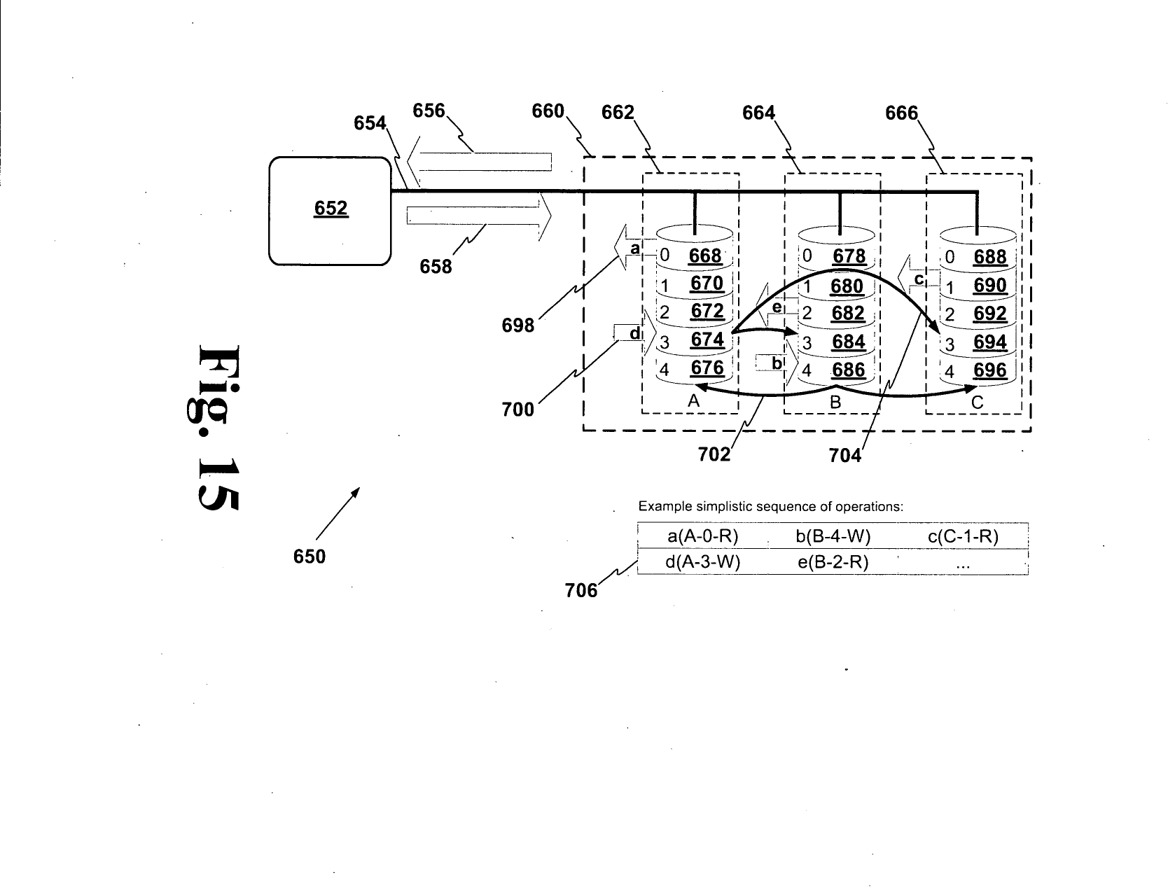

Referring to FIG. 15, an example system configuration of a client computer system logically connected via a network to a DSO 650 subject to the present disclosure is shown. In this figure a client computer system 652 interacts with a 1D-PAIMDSO 660 via a communication link 654. In this example, the DSO is envisioned to be random-access and dynamically updateable in nature and therefore the client computer system 652 will read/write data from/to the DSO. From a performance perspective, this is generally a worst-case operating scenario as it is very demanding. We refer to this configuration as a read-write 1D-PAIMDSO.

The DSO as shown consists of three columns of DSM units 662 (“A”), 664 (“B”), and 666 (“C”). Each DSO column is shown with 5 DSM units contained within. Column 662 (“A”) contains DSM units 668 (drive-0), 670, 672, 674, and 676 (drive-4). Column 664 (“B”) contains DSM units 678 (drive-0), 680, 682, 684, and 686 (drive-4). Column 666 (“C”) contains DSM units 688 (drive-0), 690, 692, 694, and 696 (drive-4). Column 662 (“A”) may be a RAID-set or it may be a collection of cooperating independent DSM units, depending on the application. A representative example of a read operation is shown as 698 and a representative example of a write operation is shown as 700. A representative example of a data replication operation from one column to others is shown as 702 and 704. A table showing an example optimized sequence of data accesses is shown as 706. Within this table a series of time-ordered entries are shown that represent a mix of read and write DSO accesses. Each table entry shows the operation identifier (i.e.: “a”), a column letter identifier (i.e.: “A” for 662), a DSM row identifier (i.e.: 0-4), and a read-write identifier (i.e.: R/W).

Like FIG. 14 it is envisioned that the original master copy of the DSO data set might start off as 662. At some point in time the DSO management software (not shown) adds additional data storage capacity in the form of 664 and 666. The replication of the data within 662 to 664 and 666 would then commence. Such replication might proceed either proactively or “lazily”. A proactive method might allocate some 662 data access bandwidth for the data replication process. A “lazy” method might replicate 662 data to 664 or 666 only as new reads or writes to the DSO are requested by 652. In either case, as each new data block is replicated and noted by the DSO management software, new read requests by 652 can then be serviced by any of the available drives. As more data blocks are replicated, higher aggregate read IO performance is achievable.

Considering DSO write operations multiple operating models are possible. Model-1 would allow reads from anywhere with valid data, but writes would always be to 662 (our master copy) with data replication operations out from there. Methods-2 might allow writes to any of the available columns with the DSO management software then scheduling writes to 662 either on a priority basis or using a “lazy” method as described earlier. Many other variations are possible depending on system needs.

It should also be noted that the above described methods can result in IO-rate performance improvements whether each column (662, 664, 666) are RAID-set (or similar) DSOs or collections of independent drives. If these columns are RAID-sets, then the IO-rate performance improvements attainable by the configuration shown is approximately 3× the performance of a single RAID-set 662. If these columns are collections of independent drives, then the IO-rate performance improvements attainable by the configuration shown is approximately 15× the performance of a single RAID-set 662.

Given that numerous columns such as 664 and 666 can be added, the amount of IO-rate performance scalability that can be achieved is generally only limited by available DSS system component resources. This method is one way of eliminating or reducing system IO-rate performance bottlenecks.

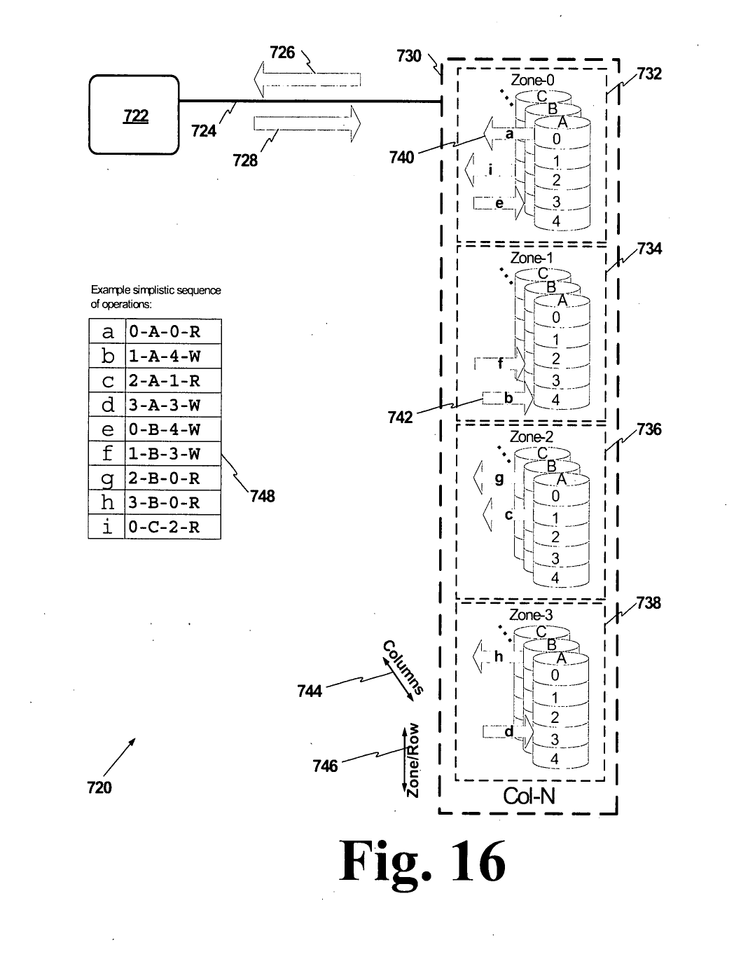

Referring to FIG. 16, an example system configuration of a client computer system logically connected via a network to a DSO 720 subject to the present disclosure is shown. In this figure a client computer system 722 interacts with a two-dimensional PAIM DSO (2D-PAIMDSO) 730 via a communication link 724. In this example, the two-dimensional PAIM DSO (2D-PAIMDSO) is envisioned to be randomly accessible and dynamically updateable in nature and therefore the client computer system will read and write data from/to the DSO. From a performance perspective, this is generally a worst-case operating scenario.

The DSO example shown consists of four DSO zones 732, 734, 736, and 738 (Zone “0”, “1”, “2”, and “3”); each Zone shown consists of three columns of DSM units (“A”, “B”, and “C”); each column consists of five DSM units (“0” through “4”). A representative read operation from Zone-“0”, column-“A”, DSM-“0” is shown by 740. A representative write operation to Zone-“1”, column-“A”, DSM-“4” is shown by 742. The “direction” of possible column expansion is shown by 744. The “direction” of possible Zone/Row expansion is shown by 746.

The table shown by 748 shows an efficient DSO access sequence for a series of read and write operations. Within this table a series of time-ordered entries are shown that represent a mix of read and write DSO accesses. Each table entry shows the operation identifier (i.e.: “a”), a Zone number (i.e.: “0”-“3”), a column letter identifier (i.e.: “A”-“C”), a row identifier (i.e.: 0-4), and a read-write identifier (i.e.: R/W). This table shows a sequence that spreads out accesses across the breadth of the DSO components so that improved performance can generally be obtained. One significant feature of the configuration shown is the ability to construct high performance DSOs from a collection of RAID-sets (within the Zones). The manner of data replication within each zone is similar to that described for FIG. 15.

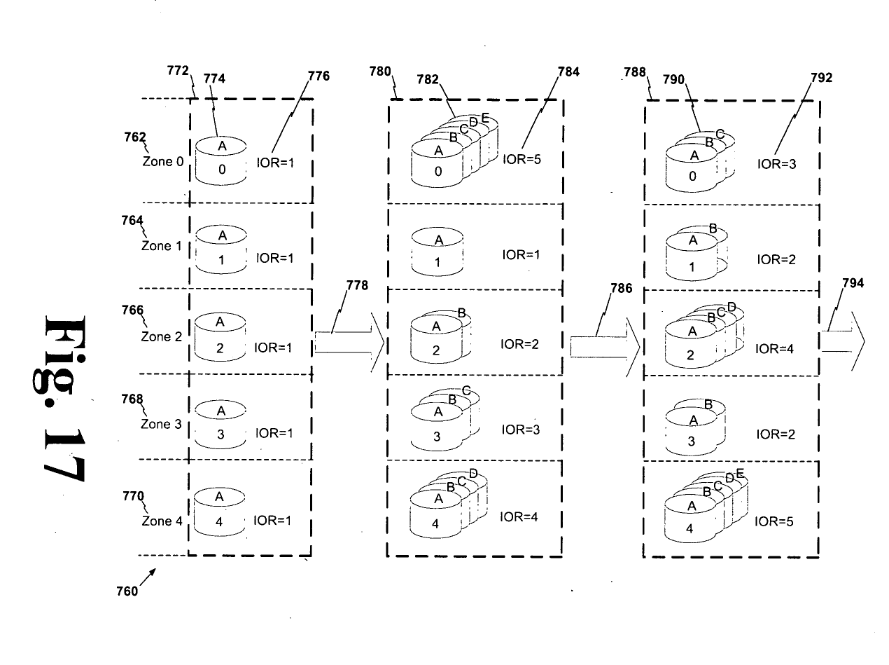

Referring to FIG. 17, an example series of 1D-PAIMDSO configurations that change over time 760 subject to the present disclosure is shown. In this figure a one dimensional Adaptive PAIM DSO (1D-APAIMDSO) 760 is shown in a number of different phases of operation. The various phases shown are Phase-1 772, Phase-2 780, and Phase-3 788. The APAIMDSO is shown divided into a series of zones 762, 764, 766, 768, and 770. In this figure the various DSM units that comprise each column (or Zone, as shown in this simple example) within the APAIMDSO are not shown separately. Instead, entire columns of DSM units are shown collectively and representatively by 774, 782, and 790. Notations similar to 776 (IOR=1), 784 (IOR=5), and 792 (IOR=3) correspond to the number of columns of DSM units currently allocated to support the zone within each phase of operation. As an example, a value of “IOR=5” means that five columns of “RAID-like” DSM units are currently allocated to support that zone within the APAIMDSO during that phase of the operation. In this case the value “5” indicates an approximate 5-times I/O-rate performance improvement over the use of a single column of DSM units is available.

Discrete points of DSO management transition are shown by 778, 786, and 794. These points in time indicate where the DSO management system has decided that it is time to adapt the allocation of DSM units based on the current workload of the DSO to meet system performance objectives. At such times additional columns of drives may be newly allocated to a zone, deleted from one zone and transferred to another zone, or deleted from a DSO entirely. The general point that should be stressed in this figure is that an APAIMDSO can adapt dynamically adapt to changing usage patterns over time so that performance objectives are continuously met, thereby it generally makes maximum use of available system resources to service “customers” with ever changing usage requirements.

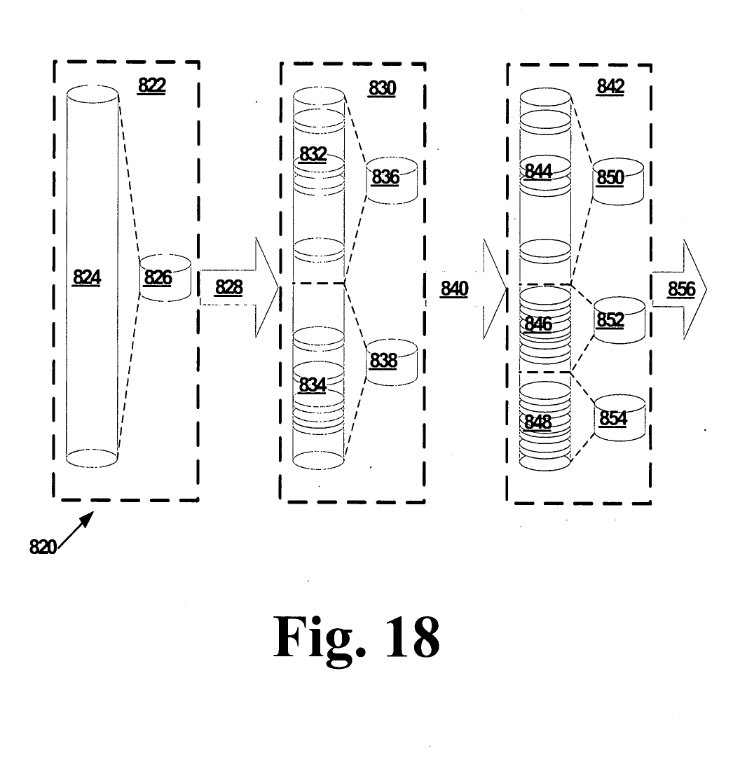

Referring to FIG. 18, an example series of states of an APAIMDSO as it dynamically reconfigures itself over time 820 subject to the present disclosure is shown. In this figure an Adaptive PAIM DSO (APAIMDSO) 820 is shown in a number of different phases of operation. The various phases shown are Phase-1 822, Phase-2 830, and Phase-3 842. This rather exotic APAIMDSO implements a “sparse matrix” type of DSO. Initially in 822, a logical DSO 824 is created of some size that is presumably much larger than a single DSM 826. Although a number of physical DSM units may be allocated to correspond to the maximum data storage capacity of the DSO, this need not necessarily be the case. Initially, a single DSM unit 826 might be allocated to provide data storage coverage over a broad expanse of logical storage space by storing only the sections of the logical storage space that have actually been written to by client systems. “Holes” within the logical DSO storage space might be logically represented by blocks of zeros until such time as they are written with other data by client systems. This convention implements a rudimentary form of logical DSO data space compression.

At some point in time 828 DSM management software might decide that a single DSM unit can no longer adequately support the amount of logical DSO storage space now actually in use. This event 828 then triggers a DSO reconfiguration and a new DSM unit would be added to the DSO during Phase-2 (830). At this time two DSM units (836 and 838) are now used to provide the physical storage space required for the overall DSO. Although not necessarily required, the reconfiguration may also involve a splitting of the logical DSO storage space (832, 834) and a reallocation of the physical DSM units used (836,838) for load balancing purposes.

Again, at some later point in time 840 DSM management software might decide that two DSM units can no longer support the amount of logical DSO storage space now actually in use. This event 840 then triggers another DSO reconfiguration and a new DSM unit is added during Phase-3 (842). At this time three DSM units (850, 852, and 854) are now used to provide the physical storage space required for the overall DSO. Although not necessarily required, the reconfiguration may also involve a splitting of the logical DSO storage space (844, 846, 848) and a reallocation of the physical DSM storage used (850, 852, 854) for load balancing purposes.

Again, at some point in time 856 DSM management software decides that three DSM units can no longer support the amount of logical DSO storage space now actually used and further reconfiguration would be performed as needed.

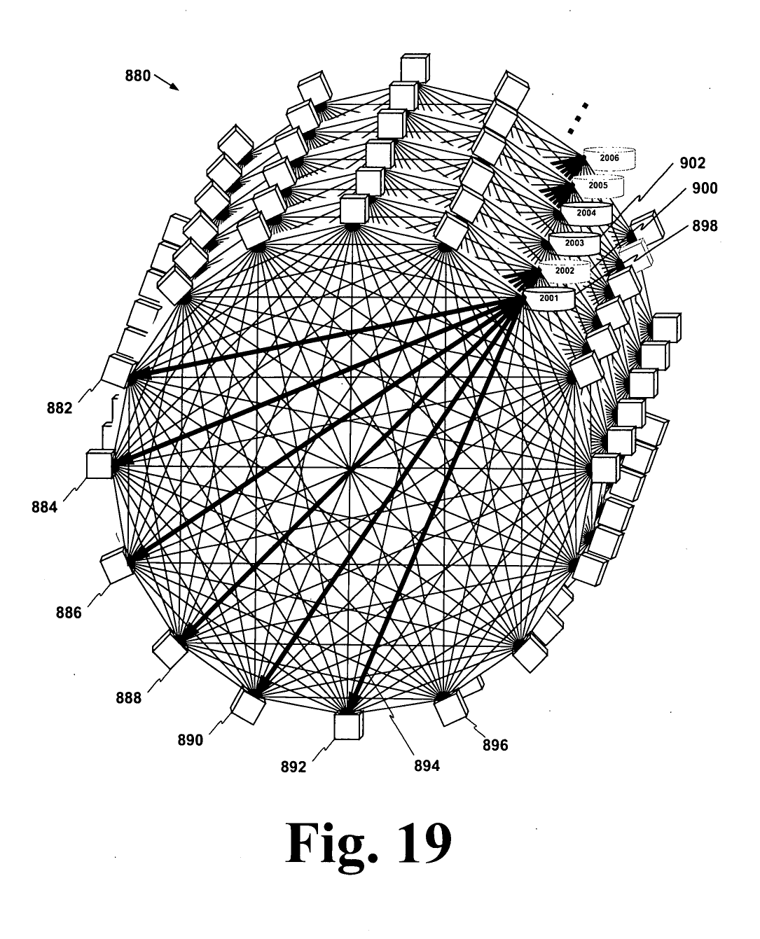

Referring to FIG. 19, an example configuration of several layers of 16 data storage system network nodes each interconnected by various logical network connectivity paths 880 subject to the present disclosure is shown. In this figure a number of system nodes (882, 884, 886, 888, 890, and 892) are shown accessing a vast block of data shown as 898 (i.e.: all year 2001 data). Because each vast block of data might itself be implemented as a network mesh has shown, each processing system node shown (882, 884, 886, 888, 890, and 892) would have some form of direct network path to the data storage system components responsible for managing the data of interest (various DSOs). Such network links are shown representatively by 894. Inactive processing system nodes are shown representatively by 896.

The figure shows a series of “layers” that are shown to include the massive data storage components shown representatively by 898, 900, 902, and others. An important point conveyed by this diagram is that massive (PB-class or EB-class) data storage systems can be constructed in layers and networked together in arbitrary ways to achieve various performance objectives.

Thus, while the preferred embodiments of devices and methods have been described in reference to the environment in which they were developed, they are merely illustrative of the principles of the inventions. Other embodiments and configurations may be devised without departing from the spirit of the inventions and the scope of the appended claims.

We claim:

1. A distributed processing data storage and processing system comprising:
a plurality of network attached components that cooperate to provide data storage functionality using time-division multiplexing aggregation methods.

2. A distributed processing data storage and processing system comprising:
a plurality data storage modules attached to network attached disk controller units exposing data storage services;
a plurality of network attached processing modules exposing data storage object processing services;
a data storage system network connectivity mechanism; and
a time-division multiplexing aggregation method used to expose high level data storage objects to a network.
